(19) United States
(12) Patent Application Publication
(10) Pub. No.: US 2024/0297311 A1
(43) Pub. Date: Sep. 5, 2024

(54) RIBBON-SHAPED ELECTRODE FOR AN ELECTROCHEMICAL ENERGY STORAGE ELEMENT

(71) Applicant: VARTA Microbattery GmbH, Ellwangen Jagst (DE)

(72) Inventor: Sebastian Schebesta, Ellwangen (DE)

(73) Assignee: VARTA Microbattery GmbH, Ellwangen Jagst (DE)

(21) Appl. No.: 18/589,815

(22) Filed: Feb. 28, 2024

(30) Foreign Application Priority Data
Mar. 1, 2023 (EP) 23159312.0

(51) Int. Cl. H01M 4/75; H01M 4/04; H01M 4/66

(52) U.S. Cl. CPC H01M 4/75; H01M 4/0404; H01M 4/0435; H01M 4/661

(57) ABSTRACT

A ribbon-shaped electrode has a ribbon-shaped current collector and a coating with electrode material on one or both sides, wherein the ribbon-shaped current collector includes a first and a second longitudinal edge, the first longitudinal edge is designed as a contact edge, the contact edge is used for electrical contacting of the electrode and the contact edge is not coated with the electrode material, the second longitudinal edge is formed as a supporting edge which is not coated with the electrode material, and the width of the supporting edge is at most 99% of the width of the contact edge.

### TECHNICAL FIELD

This disclosure relates to a ribbon-shaped electrode with a ribbon-shaped current collector and a coating of electrode material on one or both sides as well as a method of producing such a ribbon-shaped electrode, an electrochemical energy storage element and a method of producing an electrochemical energy storage element.

### BACKGROUND

Electrochemical energy storage elements are capable of converting stored chemical energy into electrical energy through a redox reaction. The simplest form of an electrochemical energy storage element is the electrochemical cell. It comprises a positive electrode and a negative electrode, which are separated from each other by a separator. During a discharge, electrons are released at the negative electrode through an oxidation process. This results in an electron current that can be tapped by an external electrical consumer, for which the electrochemical cell serves as an energy supplier. At the same time, an ion current corresponding to the electrode reaction occurs within the cell. This ion current passes through the separator and is made possible by an ion-conducting electrolyte.

If the discharge of the electrochemical energy storage element is reversible, i.e. it is possible to reverse the conversion of chemical energy into electrical energy during discharge and charge the cell or element again, this is referred to as a secondary energy storage element. The common term used for secondary elements is anode for the negative electrode and cathode for the positive electrode, which refers to the discharge function of the electrochemical energy storage element.

The term “electrochemical energy storage element” refers not only to a single electrochemical cell, but also to a battery made up of several electrochemical cells.

WO 2017/215900 A1 describes energy storage elements in the form of cylindrical round cells in which an assembly is formed from ribbon-shaped electrodes and is in the form of a coil. The electrodes each have current collectors loaded with electrode material. Oppositely polarized electrodes are arranged offset to each other within the assembly so that longitudinal edges of the current collectors of the positive electrodes emerge from the coil at one end face and longitudinal edges of the current collectors of the negative electrodes emerge from the coil at a second end face. For electrical contacting of the current collectors, the cell has contact plates that sit on the end faces of the coil and are connected to the protruding longitudinal edges of the current collectors by welding. This makes it possible to electrically contact the current collectors and thus also the associated electrodes over their entire length. This significantly reduces the internal resistance within the cell described. As a result, the occurrence of large currents can be absorbed much better. Heat can also be better dissipated from the coil.

To ensure a good connection of the longitudinal edges of the current collectors to the contact plate or conventional current arresters in such or similarly constructed energy storage elements, it is advisable to use ribbon-shaped electrodes to form the electrode-separator assembly, which have a longitudinal edge, namely the longitudinal edge to be contacted (contact edge), which is free of electrode material on both sides. Since only this longitudinal edge is required for contacting, the second longitudinal edge of the ribbon-shaped electrodes is usually coated with electrode material.

It is known to produce ribbon-shaped electrodes in a coating process in which pasty electrode materials are applied to flat current collectors. The current collectors are often ribbon-shaped metal foils (current collector ribbons). In terms of production technology, this is usually realized by providing the collectors as virtually endless ribbons (collector ribbons for short), which pass through a coating device in which they are coated with the electrode paste using a doctor blade or a nozzle. The electrode materials can be applied using a slot nozzle, for example, as described in EP 3608028 B1. In a tandem process, one side of a ribbon-shaped metal foil is often first coated with a strip of the electrode material. The ribbon coated on one side is then dried and wound up. In a later, further step, the second side of the ribbon-shaped metal foil is coated with the same electrode material, again in the form of a strip, and dried.

It is also known to apply several parallel strips of an electrode material to a ribbon-shaped metal foil to produce ribbon-shaped electrodes with a contact edge. The coated metal foil is then cut longitudinally between the strips, for example, by a laser, oftentimes preferably such that exactly one uncoated longitudinal edge remains for contacting the aforementioned contact plate. In this way, several ribbon-shaped electrodes can be produced simultaneously, each of which has a longitudinal edge free of electrode material, which can serve as a contact edge for subsequent contacting of the electrode in an electrochemical energy storage element.

To improve the mechanical and electrical contacting of the electrode components, to increase the energy density and to improve the mechanical stability of the electrode material coating, the coated current collector ribbons are usually subjected to a so-called calendering process after coating and, if necessary, drying. Calendering refers to the application of pressure to the current collector ribbon coated with the electrode material. For example, two rollers (calender rollers) are used, which form a gap that is smaller than the initial thickness of the coated current collector ribbon. The coated current collector ribbon is fed through this gap and compacted. This also allows specifically defined porosities of the coating to be set.

During calendering, the calender rollers generally exert such strong pressure on the coated current collector ribbon that not only the electrode material is compacted but also the current collector ribbon is also deformed by compression and, in particular, lengthened in the longitudinal direction. The problem is that this deformation only occurs in areas of the collector ribbon which are coated with electrode material, as the pressure of the calender rollers is only transferred to these areas. Areas of the current collector ribbon which are not covered by electrode material can pass through the calender rollers without being deformed, as their thickness is less than the width of the gap between the rollers.

This is problematic in that the ribbon-shaped electrode emerging from the calender can bend and warp to relieve stresses caused by the partial deformation. Warping and corrugation can occur, particularly in the area of a longitudinal edge that is not coated with electrode material. These deformations can cause major problems during further processing of the electrode ribbons, for example, in the manufacture of electrode coils. Generally, additional technical effort is required to mechanically process such deformed ribbons.

Various approaches already exist to compensate for deformations that occur during calendering processes. It is known from JP 2014220113 A to provide a device for stretching free areas before and after compaction. It is known from DE 102011088824 A1 to adapt uncoated areas of ribbon-shaped current collectors to the coated area by a forming process. The use of heat to treat uncoated areas is known from EP 2637238 B1. To solve the problem, EP 4016664 A1 proposes selective plastic stretching of the uncoated areas with the aid of a conveying device and a braking device during the calendering process.

These approaches have not yet led to a satisfactory solution to the problem, as they are relatively complex.

It could therefore be helpful to provide a simplified technical solution with which deformation of the electrode can be prevented or at least significantly reduced with simple measures.

### SUMMARY

I provide a ribbon-shaped electrode with a ribbon-shaped current collector and a coating with electrode material on one or both sides, wherein the ribbon-shaped current collector includes a first and a second longitudinal edge, the first longitudinal edge is designed as a contact edge, the contact edge is used for electrical contacting of the electrode and the contact edge is not coated with the electrode material, the second longitudinal edge is formed as a supporting edge which is not coated with the electrode material, and the width of the supporting edge is at most 99% of the width of the contact edge.

### BRIEF DESCRIPTION OF THE DRAWINGS

FIG. 1 is a schematic representation of a multi-track layer application on a ribbon-shaped current collector for the production of ribbon-shaped electrodes with a longitudinal edge (contact edge) according to the prior art.

FIG. 2 is a schematic representation of a multi-track layer application on a ribbon-shaped current collector for the production of ribbon-shaped electrodes with two free edges (contact edge and support edge).

FIG. 3 is a photographic representation of a ribbon-shaped electrode.

FIG. 4 shows an energy storage element in the form of a cylindrical round cell.

### DETAILED DESCRIPTION

My ribbon-shaped electrode is provided as a component of an electrochemical energy storage element. The ribbon-shaped electrode comprises a ribbon-shaped current collector and a coating of electrode material on one or both sides. Preferably, the electrode is coated on both sides with the electrode material. Furthermore, the ribbon-shaped electrode is characterized by:
a. the ribbon-shaped current collector comprises a first and a second longitudinal edge, wherein the first longitudinal edge is designed as a contact edge, wherein the contact edge is used for electrical contacting of the electrode and wherein the contact edge is not coated with the electrode material.

The ribbon-shaped electrode is further characterized by:
b. the second longitudinal edge is formed as a supporting edge and is not coated with the electrode material. Preferably, the second longitudinal edge is not coated with electrode material on both sides, and
c. the width of the supporting edge is a maximum of 99%, preferably a maximum of 90%, particularly preferably a maximum of 50%, of the width of the contact edge.

According to the aforementioned a. to d., my ribbon-shaped electrode has two uncoated longitudinal edges, these two free longitudinal edges differing in width, which gives the electrode an asymmetry in the longitudinal direction.

The wider of the uncoated longitudinal edges is designed as a contact edge. This contact edge is provided, for example, for contacting the electrode to a current conductor. In particular, the contact edge can be used for contacting the electrode with a contact plate or a similar contact element, for example, according to the above-mentioned WO 2017/215900 A1.

The other longitudinal edge of the electrode is designed as a supporting edge and counteracts deformation of the ribbon-shaped electrode, which conventionally occurs when the electrode material is calendered, i.e. when the electrode material is compacted. In general, calendering is advantageous for improving the adhesion of the electrode material to the current collector and thus for improving the mechanical stability of the electrodes. At the same time, calendering increases the energy density of the resulting electrochemical energy storage element, as already explained above. The uneven deformation of the ribbon-shaped electrode associated with calendering is avoided or reduced in the electrode. This is surprisingly achieved by the presence of the supporting edge. My tests have shown that even a narrow supporting edge can very effectively prevent deformation and warping of the ribbon-shaped electrode as a result of calendering.

Whereas oftentimes, according to conventional methods, current collectors coated with electrode material with only one uncoated longitudinal edge were to be subjected to calendering for the production of electrodes such as those used according to WO 2017/215900 A1, it is intended to calender current collectors with two uncoated longitudinal edges, one of the longitudinal edges being narrower than the other. The supporting edge serves to stabilize the linear shape of the ribbon-shaped electrode, while the contact edge serves to make electrical contact with the electrode within the energy storage element to be produced. The support edge is not intended for making electrical contact with a current collector or a cell housing.

Both the first longitudinal edge and the second longitudinal edge of the electrode are preferably not coated with electrode material on both sides, i.e. both sides are free of electrode material.

Preferably, the width of the supporting edge and/or the width of the contact edge is constant or at least essentially constant over its entire length.

Particularly preferably, the electrode material coating of the ribbon-shaped electrode is present in compacted form, this compacted form of the electrode material having been produced by a calendering process, i.e. compaction under pressure. The particular advantage, namely the avoidance of deformation as a result of calendering, comes into play in particular with already calendered ribbon-shaped electrodes. On the other hand, this disclosure also includes ribbon-shaped electrodes according to the above description which are not (yet) calendered. In these ribbon-shaped electrodes, the particular advantage only becomes apparent after the electrode material has been compacted.

According to the aforementioned d., the width of the supporting edge is at most 99%, preferably at most 90%, particularly preferably at most 50%, of the width of the contact edge. The support edge is therefore narrower than the contact edge. This is also practical because the space required for the support edge can be kept to a minimum. The supporting edge essentially only fulfills its function in the manufacture of the electrode. In an electrochemical cell, it is merely ballast.

My tests have shown that even a supporting edge that is only half the width of the contact edge or less has the desired effect and reliably counteracts deformation of the ribbon-shaped electrode. It is therefore particularly preferred that the width of the supporting edge is at most 50% of the width of the contact edge.

In further preferred configurations of the ribbon-shaped electrode, the electrode is characterized by at least one of:
a. the supporting edge has a width of 10% to 50%, preferably 10% to 40%, particularly preferably 10% to 30%, of the width of the contact edge;
b. the supporting edge has a width of at most 45%, preferably at most 40%, further preferably at most 35%, further preferably at most 30%, particularly preferably at most 25%, of the width of the contact edge;
c. the supporting edge has a width of 5% to 25% of the width of the contact edge; and
d. the support edge has a width of 5% to 20% of the width of the contact edge.

My tests have shown that even a width of the supporting edge in the specified ranges is sufficient to counteract deformation.

Of course, the absolute values for the width of the contact edge and the width of the support edge depend on the respective dimensions of the ribbon-shaped electrode and the energy storage elements to be produced.

The total width of the electrodes is variable and can be adapted depending on the dimensions of the energy storage element to be produced. It is generally intended that the respective width of the ribbon-shaped electrodes is constant over its entire length. In particular, the width of my ribbon-shaped electrodes is up to 500 mm. Preferably, the width of the ribbon-shaped electrodes is 5 to 300 mm. Particularly preferably, the width of the ribbon-shaped electrodes is 20 to 200 mm.

The width of the contact edge and the width of the support edge can be adjusted depending on the overall width of the ribbon-shaped electrodes. The width of the contact edge can, for example, be 1-30%, preferably 5-20%, preferably 10-15%, of the total width of the ribbon-shaped electrode. In some preferred configurations, the width of the contact edge is up to 50 mm, preferably 1 to 30 mm.

For example, the following features can be provided with regard to the dimensions of the contact edge and the support edge:
a. the contact edge has a width of up to 2 mm and the support edge has a width of up to 0.5 mm; and
b. the contact edge has a width of up to 20 mm or more and the support edge has a width of up to 5 mm.

Preferably, the ribbon-shaped electrode is characterized by one of:
a. the electrode is a cathode and the ribbon-shaped current collector is formed by an aluminum foil; and
b. the electrode is an anode and the ribbon-shaped current collector is formed by a copper foil.

The configuration of the electrode as a cathode with a ribbon-shaped current collector made of aluminum foil according to the aforementioned a. is particularly preferred, since in particular with such a cathode in conventional electrodes a particularly strong deformation of the ribbon-shaped electrode can be observed as a result of the calendering process. The advantages are therefore particularly evident with such a cathode.

In other configurations, the metal foil of the ribbon-shaped current collector can also be formed on the basis of an alloy, for example, an aluminum alloy for the cathode or a copper alloy for the anode. Nickel or a nickel alloy, for example, is also suitable for the current collector of the anode.

In principle, all known electrode materials for various types of energy storage elements that are conventionally used for coating a ribbon-shaped current collector are suitable as electrode materials for coating the ribbon-shaped electrode. For the formation of a negative electrode, for example, carbon-based particles such as graphitic carbon can form the basis for the electrode material. Lithium nickel oxide or lithium cobalt oxide or lithium manganese oxide or lithium iron phosphate or derivatives thereof can be used as the basis for the electrode material of a positive electrode, for example. These materials are particularly suitable for electrodes that are intended for the production of lithium-ion energy storage elements.

I further provide a method of manufacturing the described ribbon-shaped electrode. This method initially comprises:
a. a ribbon-shaped current collector is provided, the width of which has at least the width of the ribbon-shaped electrode to be produced;
b. the ribbon-shaped current collector is coated on one or both sides with a strip of electrode material so that a first longitudinal edge of the current collector and a second longitudinal edge of the current collector remain free of the electrode material; and
c. the current collector coated with the electrode material is subjected to calendering to compact the electrode material.

The coating and/or the further processing for producing the electrode is carried out such that the width of the second longitudinal edge of the electrode to be produced, which is not coated with the electrode material, is at most 99%, preferably at most 90%, of the width of the first longitudinal edge, which is not coated with the electrode material. In this way, a ribbon-shaped electrode is produced in which the wider longitudinal edge forms the contact edge of the electrode. This contact edge is used for electrical and, if necessary, mechanical contacting and fixing of the electrode in the energy storage element to be produced. The narrower longitudinal edge of the electrode is not used for contacting, but forms a supporting edge for the electrode to counteract deformation of the ribbon-shaped electrode as a result of calendering or compaction of the electrode material under pressure and thus stabilize a linear shape of the electrode.

The longitudinal edges of the ribbon-shaped electrode that are not coated with electrode material can be formed in different ways. In particular, one or more of the following methods can be used for this purpose:
a. the electrode material is applied to the current collector such that the width of the second longitudinal edge that is not coated with the electrode material is at most 90%, preferably at most 50%, of the width of the first longitudinal edge that is not coated with the electrode material,
and/or
b. the first and/or the second longitudinal edge is trimmed after coating with the electrode material such that the width of the second longitudinal edge not coated with the electrode material is at most 90%, preferably at most 50%, of the width of the first longitudinal edge not coated with the electrode material,
and/or
c. after coating, electrode material is removed from the current collector in certain areas so that the width of the second longitudinal edge not coated with the electrode material is at most 90%, preferably at most 50%, of the width of the first longitudinal edge not coated with the electrode material.

Particularly preferably, the following additional features are provided in the method:
a. the ribbon-shaped current collector has a width which is a multiple of the width of the ribbon-shaped electrode to be produced;
b. the coating with the electrode material is carried out by applying two or more coating strips of the electrode material to the current collector and by maintaining strip-shaped free spaces (12) between adjacent coating strips; and
c. the ribbon-shaped current collector is cut in the longitudinal direction of the ribbon-shaped current collector within the free spaces between the adjacent coating strips.

This procedure according to the aforementioned a. to c. is particularly suitable for fast and cost-effective production of a plurality of ribbon-shaped electrodes. This procedure is particularly suitable for mass production.

The two or more coating strips of the electrode material are preferably applied in parallel to the current collector.

Preferably, the cutting, preferably the cutting, c. does not take place along the center line of the free space between the coating strips, but such that a ribbon-shaped electrode results directly, which has free edges of different widths at its two longitudinal edges.

The current collector can be cut in accordance with the aforementioned process step c. using a laser, for example.

In principle, the compaction of the electrode material under pressure, i.e. the calendering, can take place before or after cutting through or separating the ribbon-shaped electrodes in accordance with the aforementioned process step c. Particularly preferably, however, the calendering of the coated current collector takes place before the ribbon-shaped current collector is cut through, since the coating is mechanically stabilized and made insensitive by the calendering with regard to the subsequent further processing and in particular with regard to cutting. In this configuration, the current collector coated with several strips is held in shape during calendering by the free spaces between the strips. After the current collector has been cut, the shape of the ribbon-shaped electrodes is maintained by the respective supporting edges and subsequent distortion of the electrodes is avoided.

In principle, however, the current collector can also be cut before calendering, as the support edge stabilizes the shape of the electrode during subsequent calendering, even if it is already present in isolated form.

I further provide an electrochemical energy storage element comprising at least one ribbon-shaped electrode as described above. In principle, this energy storage element can be any conceivable configuration of energy storage elements which are produced using a ribbon-shaped electrode and which are familiar to those skilled in the art. In particular, this includes energy storage elements with at least one of:
a. the electrodes of the electrochemical energy storage element are wound up to form a coil;
b. the electrodes of the electrochemical energy storage element are stacked; and
c. the energy storage element has at least one current arrester that is directly coupled to the contact edge of the ribbon-shaped electrode by welding.

Preferably, the aforementioned a. and c. or alternatively b. and c. are realized in combination with each other.

Particularly preferably, the ribbon-shaped electrodes are suitable for further processing to a coil, for example, for the production of button cells or round cells, e.g. in the 21700 format. Stabilization of the linear shape of the ribbon-shaped electrode facilitates the winding process compared to the processing of conventionally produced ribbon-shaped electrodes, in which the deformation that occurs often makes processing more difficult.

There are also advantages for the manufacture of energy storage elements which comprise electrodes in stacked form. Here too, the stabilization of the linearity of the ribbon-shaped electrodes facilitates processing, for example, when punching out stacked cells from rolled-up electrode ribbons.

The stabilized ribbon-shaped electrodes are particularly suitable for the production of round cells with a contact plate design according to WO 2017/215900 A1, whereby a plate-shaped contact element is coupled directly to the contact edge of the electrode. Such a plate-shaped contact element can serve as a current arrester according to the aforementioned c. With regard to further details of such a design of cylindrical round cells, reference is made, for example, to WO 2017/215900 A1.

Particularly preferably, the electrochemical energy storage element that can be produced is a lithium-ion energy storage element. In other configurations, it may be, for example, a sodium-ion energy storage element or an element on another electrochemical basis.

A particular advantage of lithium-ion energy storage elements is that these elements can provide high currents and are characterized by comparatively high energy densities. They are based on the use of lithium, which can move back and forth between the electrodes of the element in the form of ions. The negative electrode and the positive electrode of a lithium-ion energy storage element are usually formed by so-called composite electrodes, which include electrochemically inactive components as well as electrochemically active components.

In principle, all materials that can absorb and release lithium ions can be used as electrochemically active components (active materials) for secondary lithium-ion elements. For example, carbon-based particles such as graphitic carbon are used for the negative electrode. Active materials that can be used for the positive electrode include lithium nickel oxide (LiNiO₂), lithium cobalt oxide (LiCoO₂), lithium manganese oxide (LiMn₂O₄), lithium iron phosphate (LiFePO₄) or derivatives thereof. The electrochemically active materials are usually contained in the electrodes in particle form.

The ribbon-shaped current collector of the energy storage element represents an electrochemically inactive component of the element. Preferably the current collector is a metallic foil that serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example, carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion energy storage elements usually comprise solutions of lithium salts such as lithium hexafluorophosphate (LiPF₆) in organic solvents (e.g. ethers and esters of carbonic acid).

The composite electrodes are generally combined with one or more separators to form an electrode-separator assembly when manufacturing a lithium-ion element. The electrodes and separators are often, but not necessarily, joined together under pressure, in some configurations also by lamination or bonding. The basic functionality of the energy storage element can then be established by impregnating the assembly with an electrolyte.

In many examples of lithium-ion energy storage elements, the electrode-separator assembly is formed in the form of a coil or processed into a coil. In the first configuration, for example, a ribbon-shaped current collector positive electrode and a ribbon-shaped current collector negative electrode as well as at least one ribbon-shaped current collector separator are fed separately to a winding machine and spirally wound into a coil with the sequence positive electrode/separator/negative electrode. In the second configuration, a ribbon-shaped current collector positive electrode and a ribbon-shaped current collector negative electrode as well as at least one ribbon-shaped current collector separator are first combined to form an electrode/separator assembly, for example, by applying the aforementioned pressure. In a further step, the assembly is then wound up before this electrode-separator assembly is inserted into a housing.

Electrode windings can be produced at very high speed and therefore at comparatively low cost. Wound cell technology is suitable for the production of both prismatic cells and round cells.

Finally, I provide a method of manufacturing an electrochemical energy storage element using at least one ribbon-shaped electrode as described above. Preferably, this method is characterized by at least one of:
a. the at least one ribbon-shaped electrode is processed to form an electrode/separator assembly in the form of a coil or an electrode/separator assembly in the form of a stack; and
b. the at least one ribbon-shaped electrode is electrically contacted with elements of the energy storage element to be produced, in particular with housing elements of the energy storage element, wherein the electrical contacting of the at least one ribbon-shaped electrode takes place via the contact edge of the ribbon-shaped electrode.

Compared to conventional manufacturing methods, this method has the particular advantage that the stabilization of the linearity of the ribbon-shaped electrodes achieved considerably facilitates the further processing of the electrodes, for example, with regard to a winding process or to the further cutting and processing of the electrodes.

Further features and advantages of my electrodes are shown in the following description of preferred examples in conjunction with the drawings.

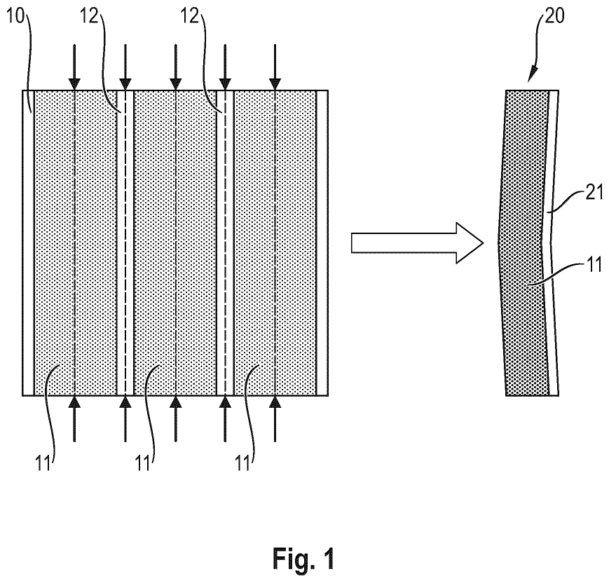

FIG. 1 schematically illustrates the production of ribbon-shaped electrodes according to a conventional process (prior art). As shown on the left-hand side of the illustration, the electrode material is applied in three parallel strips 11 to a ribbon-shaped current collector 10, which has a width which is a multiple (6×) of the width of the ribbon-shaped electrode 100 to be produced. Between the strips 11 there are strip-shaped free spaces 12 which are not coated with the electrode material. To produce the ribbon-shaped electrodes, parallel cuts are made in the longitudinal direction of the ribbon-shaped current collector 10 along the dashed lines through the middle of the coating strips 11 and through the middle of the free spaces 12, indicated by the arrows from above and below. A ribbon-shaped electrode 20 obtained by this method is shown on the right-hand side of the figure. One longitudinal edge 21 of this ribbon-shaped electrode 20 is not coated with the electrode material 11, while the other is coated. This longitudinal edge 21 is generally intended for contacting the electrode within an energy storage element to be manufactured.

The electrode material of the electrode 20 shown can be compacted as part of a calendering process. The problem is that the non-uniform deformation of the current collector during calendering can result in a crescent-shaped deformation and warping of the resulting electrode 20, which makes further processing of the electrode 20 more difficult. The sickle shape of the resulting electrode 20 illustrates a clear deviation from a strictly linear shape.

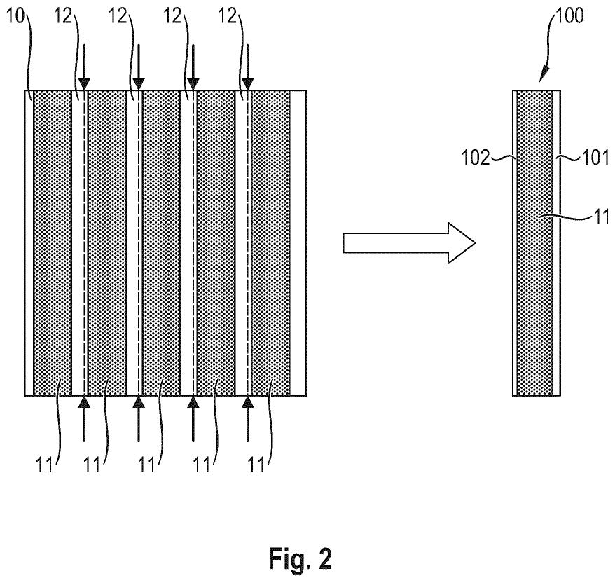

FIG. 2 illustrates the solution to this problem. Here too, the electrode material is applied to the ribbon-shaped current collector 10, which has several times the width of the electrodes to be produced, in the form of strips 11. Between these strips free spaces 12 are located. However, here the strips are already applied in the width required for the electrode to be produced, whereas in the procedure illustrated in FIG. 1, the strips are applied in double the width. In the method, the cutting lines for producing the electrodes 100 are set asymmetrically and thus not along the center lines within the free spaces 12, indicated here by arrows from above and below. This cutting pattern produces ribbon-shaped electrodes 100 which have two longitudinal edges free of electrode material. The first, wider longitudinal edge 101 serves as a contact edge for the electrical and/or mechanical contacting of the electrode 100 in an energy storage element to be manufactured. The second, narrower longitudinal edge 102 serves as a supporting edge and prevents uneven deformation of the electrode 100 during calendering.

Calendering generally results in the current collector, for example, the collector foil, being stretched. However, this only occurs in the coated area of the foil so that the electrode is deformed unevenly. The supporting edge 102 of the electrode 100 has the effect of mechanically stabilizing the ribbon-shaped electrode and prevents the ribbon-shaped electrode from forming curves or crescent-shaped deformation. The supporting edge 102 thus fulfills a supporting function or, more precisely, a tensile function so that the linear shape of the ribbon-shaped electrode 100 is maintained and thus the electrode can be further processed with significantly better linearity in all subsequent processing steps. This plays a particularly important role in the winding of electrode coils. However, this is also very advantageous when processing rolled-up electrode strips, which are processed into stack cells, for example, and punched out in automatic machines for further processing.

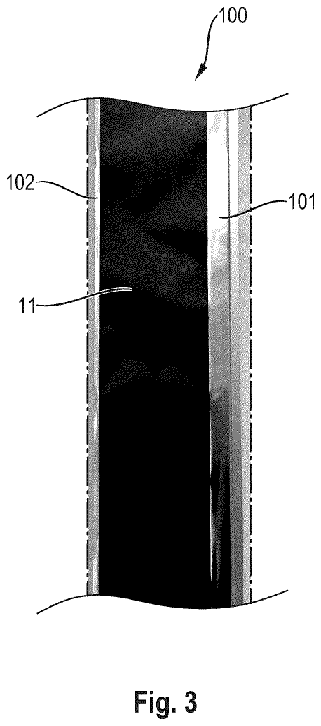

FIG. 3 shows a photographic image of a section of a ribbon-shaped electrode 100. The ribbon-shaped current collector, which is formed by a metal foil (aluminum), is provided with a coating 11 of electrode material. This coating is on both sides. Both longitudinal edges of the ribbon-shaped electrode 100 are free of the electrode material, whereby in this illustration the right longitudinal edge 101 is wider than the left longitudinal edge 102. The right-hand longitudinal edge 101 serves as a contact edge and is intended for electrical and possibly also mechanical contacting of the processed electrode in an energy storage element to be manufactured. The left, narrower longitudinal edge 102 forms a supporting edge and ensures that the ribbon-shaped electrode 100 does not deform and warp unevenly as a result of the calendering process intended for manufacturing the electrode. As this photographic representation shows, the linearity of the ribbon-shaped electrode 100 is completely preserved and no crescent-shaped or other deformation of the electrode 100 can be detected.

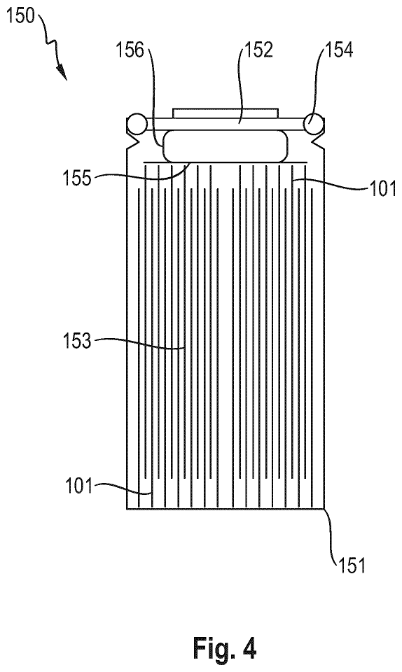

FIG. 4 shows an energy storage element 150 in the form of a cylindrical round cell. The energy storage element 150 comprises a metallic housing with a housing cup 151 and a housing cover 152. A wound electrode-separator assembly 153 in cylindrical form is enclosed in the housing. The housing is cylindrical overall, with the housing cup 151 having a round base, a hollow cylindrical shell and a round opening opposite the base. The housing cover 152 serves to close the round opening of the housing cup 151. The housing cover 152 is sealed and electrically insulated from the housing cup 151 in the area of the round opening by a circumferential seal 154. The housing is closed, for example, by flanging.

The electrode-separator assembly 153 is in the form of a cylindrical coil, which is formed from a ribbon-shaped positive electrode and a ribbon-shaped negative electrode as well as at least one ribbon-shaped separator arranged between the electrodes. The ribbon-shaped electrodes each have a contact edge 101 which is not coated with an electrode material and which is used for electrical contacting with the corresponding elements of the housing. A supporting edge, not shown here in detail, is provided on the respective opposite longitudinal edge of the ribbon-shaped electrodes to stabilize the linear shape of the electrodes, which is also not coated with electrode material and which is somewhat narrower than the contact edge.

The ribbon-shaped electrodes are wound to produce the electrode-separator assembly 153 such that the ribbon-shaped electrodes in the electrode-separator assembly 153 are arranged offset to one another so that the contact edge 101 of one electrode protrudes on one of the end faces, and the contact edge 101 of the other electrode protrudes on the opposite end face of the winding, as schematically indicated in FIG. 4.

For example, the contact edge 101 in the lower part of this illustration represents the contact edge of the negative electrode and is accordingly formed by the uncoated anode current collector. On the upper side of the electrode-separator assembly 153 in this example, the contact edge 101 of the positive electrode, which is formed by the uncoated cathode current collector, protrudes accordingly.

The contact edge 101 of the negative electrode projecting at the bottom is in direct contact with the base of the housing cup 151 over its entire length and is connected to the latter by welding over at least several sections, preferably over its entire length. The upper projecting contact edge 101 of the positive electrode is in direct contact with a metallic contact plate (contact element) 155 over its entire length and is connected to it by welding over at least several sections, preferably over its entire length. The contact plate 155 is in turn electrically connected to the housing cover 152 via an electrical conductor 156. Preferably, there is a welded connection between the conductor 156 and the contact plate 155 on the one hand and the electrical conductor 156 and the housing cover 152 on the other. For a better overview, the ribbon-shaped electrodes are only shown schematically and without further detailed components of the electrode-separator assembly 153 (in particular separators and electrode materials). In this example, the housing cup 151 forms the negative pole and the housing cover 152 forms the positive pole of the energy storage element 150.

In prismatic configurations, a section through an energy storage element could in principle look the same. In this example, the housing cup 151 would have a rectangular base, a rectangular side wall and a rectangular cross-section as well as a rectangular opening. The housing cover 152 would be designed to close the rectangular opening. Instead of a coil-shaped electrode/separator assembly, the reference sign 153 in a prismatic cell could designate a stack of several identical electrode/separator assemblies, each with exposed contact edges of the electrodes.

1. A ribbon-shaped electrode with a ribbon-shaped current collector and a coating with electrode material on one or both sides, wherein
a. the ribbon-shaped current collector comprises a first and a second longitudinal edge,
b. the first longitudinal edge is designed as a contact edge, the contact edge is used for electrical contacting of the electrode and the contact edge is not coated with the electrode material,
c. the second longitudinal edge is formed as a supporting edge which is not coated with the electrode material, and
d. the width of the supporting edge is at most 99% of the width of the contact edge.

2. The ribbon-shaped electrode according to claim 1, wherein at least one of:
a. the supporting edge has a width of 10% to 50% of the width of the contact edge;
b. the supporting edge has a width of at most 45% of the width of the contact edge;
c. the supporting edge has a width of 10% to 25% of the width of the contact edge; and
d. the supporting edge has a width of 10% to 20% of the width of the contact edge.

3. The ribbon-shaped electrode according to claim 1, wherein one of:
a. the contact edge has a width of up to 2 mm and the support edge has a width of up to 0.5 mm; and
b. the contact edge has a width of up to 20 mm or more and the support edge has a width of up to 5 mm.

4. The ribbon-shaped electrode according to claim 1, wherein any one of:
a. the electrode is a cathode and the ribbon-shaped current collector is formed by an aluminum foil; and
b. the electrode is an anode and the ribbon-shaped current collector is formed by a copper foil.

5. A method of manufacturing a ribbon-shaped electrode according to claim 1, comprising:
a. providing a ribbon-shaped current collector, the width of which has at least the width of the ribbon-shaped electrode to be produced,
b. coating the ribbon-shaped current collector on one or both sides with a strip of electrode material so that a first longitudinal edge of the current collector and a second longitudinal edge of the current collector remain free of the electrode material, and
c. subjecting the current collector coated with the electrode material to calendering to compact the electrode material,
wherein
d. the electrode material is applied to the current collector such that the width of the second longitudinal edge not coated with the electrode material is at most 90% of the width of the first longitudinal edge not coated with the electrode material,
and/or
e. the first and/or the second longitudinal edge is trimmed after coating with the electrode material such that the width of the second longitudinal edge not coated with the electrode material is at most 90% of the width of the first longitudinal edge not coated with the electrode material,
and/or
f. electrode material is removed from the current collector in certain areas after coating so that the width of the second longitudinal edge not coated with the electrode material is at most 90% of the width of the first longitudinal edge not coated with the electrode material.

6. The method according to claim 5, wherein:
a. the ribbon-shaped current collector has a width which is a multiple of the width of the ribbon-shaped electrode to be produced;
b. the coating with the electrode material is carried out by applying two or more coating strips of the electrode material to the current collector and by maintaining strip-shaped free spaces between adjacent coating strips; and
c. the ribbon-shaped current collector is cut through in the longitudinal direction of the ribbon-shaped current collector within the free spaces between the coating strips.

7. The method according to claim 6, wherein:
a. the coated current collector is calendered before the ribbon-shaped current collector is cut.

8. An electrochemical energy storage element, wherein the electrochemical energy storage element comprises at least one ribbon-shaped electrode according to claim 1.

9. The electrochemical energy storage element of claim 8, comprising at least one of:
a. the electrodes of the electrochemical energy storage element are wound up to form a coil;
b. the electrodes of the electrochemical energy storage element are stacked; and
c. the energy storage element has at least one current arrester which is directly coupled to the contact edge of the ribbon-shaped electrode by welding.

10. The electrochemical energy storage element according to claim 9, wherein:
a. the electrochemical energy storage element is a lithium-ion energy storage element or a sodium-ion energy storage element.

11. A method of producing an electrochemical energy storage element, wherein at least one ribbon-shaped electrode according to claim 1 is used.

12. The method according to claim 11, wherein at least one of:
a. the at least one ribbon-shaped electrode is processed to form an electrode/separator assembly in the form of a coil or an electrode/separator assembly in the form of a stack; and
b. the at least one ribbon-shaped electrode is electrically contacted with elements of the energy storage element to be produced and the electrical contacting of the at least one ribbon-shaped electrode takes place via the contact edge of the ribbon-shaped electrode.
